(19) United States
(12) Patent Application Publication
(10) Pub. No.: US 2017/0055762 A1
(43) Pub. Date: Mar. 2, 2017

(54) Particulate Collection Device

(71) Applicant: Gerard John LYNCH, Middlesex, NJ (US)

(72) Inventor: Gerard John LYNCH, Middlesex, NJ (US)

(21) Appl. No.: 14/834,622

(22) Filed: Aug. 25, 2015

(51) Int. Cl. A47J 31/44; B01D 35/30; B01D 35/02

(52) U.S. Cl. CPC A47J 31/446; B01D 35/02; B01D 35/30; B01D 35/306

(57) ABSTRACT

A particulate collection system for collecting and disposing of the contents of a reusable filters is provided. The particulate collection system may embody particulate collection device facilitating the flow of a wash fluid through the reusable filter, carrying along its particulate contents, and into an enclosure, wherein the particulates may captured within the enclosure, while the wash fluid is discharges there from. The particulate collection device may include a filter seat and a particulate filter-collector removably attachable in a sealing engagement. The particulate filter-collector forms the enclosure housing a filter or a filter mesh. The filter seat forms a rinse chamber for the reusable filter to be submerged by wash fluid, wherein the rinse chamber and circumscribing portions thereof may be in fluid communication with the enclosure.

### BACKGROUND OF THE INVENTION

The present invention relates to collection devices and, more particularly, to a device for the cleaning of and collecting particulates from reusable filters for brewing systems that use pre-filled filter packs.

Today the use of coffee brewing systems that use pre-filled reusable filters is widespread. Such systems include but are not limited to Keurig® K-Cup brewing systems. Because such systems do not have a collection process for the heated and moisture-laden particulate contents, a user of such system must tap and/or rinse the particulate contents from the reusable filters, usually over a sink or garbage. Such a disposal process necessitates handling the heated and messy contents that may clog the sink. Consequently, many users of such systems choose to use pre-filled disposable filter pack K-Cups, wasting both money and producing more environmental waste.

Evidently, there is a need for a device that simplifies the receiving and collection of the particulate from brewing system re-usable K-Cups and filter packs. A device that can clean K-Cup and Filter packs in a convenient, less wasteful, time saving manner.

### SUMMARY OF THE INVENTION

In one aspect of the present invention, particulate collection device includes a particulate filter-collector having at least one sidewall forming an enclosure communicating with a fluid opening; a plurality of drainage apertures formed along the at least sidewall; and a filter seat forming a centrally disposed chamber wall, wherein the filter seat is in fluid communication with the enclosure, wherein the fluid opening and the filter seat peripheries are dimensioned and adapted to form a removable sealing engagement.

In another aspect of the present invention, particulate collection device includes a particulate filter-collector having at least one sidewall forming an enclosure communicating with a fluid opening; a plurality of drainage apertures formed along the at least sidewall; a filter seat forming a centrally disposed chamber wall, wherein the chamber wall forms a rinse chamber in fluid communication with the enclosure; a plurality of fluid apertures formed in the filter seat so as to circumscribe the chamber wall, wherein the plurality of fluid apertures are oriented approximately normal to a bottom portion of the chamber wall; and a disposable filter housed within the enclosure, wherein the fluid opening and the filter seat peripheries are dimensioned and adapted to form a removable sealing engagement.

In yet another aspect of the present invention, a particulate collection device includes a particulate filter-collector having at least one sidewall forming an enclosure communicating with a fluid opening; a plurality of drainage apertures formed along the at least sidewall, wherein the plurality of drainage apertures are dimensioned to filter particulates; a filter seat forming a centrally disposed chamber wall, wherein the chamber wall forms a rinse chamber in fluid communication with the enclosure; and a plurality of fluid apertures formed in the filter seat so as to circumscribe the chamber wall, wherein the plurality of fluid apertures are oriented along an angle approximately defined by an upper portion of the chamber wall to the periphery of the filter seat, wherein the fluid opening and the filter seat peripheries are dimensioned and adapted to form a removable sealing engagement.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention;

FIG. 2 is an exploded perspective view of an exemplary embodiment of the present invention;

FIG. 3 is a cross-sectional view of an exemplary embodiment of the present invention, taken along line 3-3 of FIG. 1;

FIG. 4 is a front perspective view of an exemplary embodiment of the present invention;

FIG. 5 is an exploded perspective view of an exemplary embodiment of the present invention; and

FIG. 6 is a cross-sectional view of an exemplary embodiment of the present invention, taken along line 6-6 of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a particulate collection system for collecting and disposing of the contents of a reusable filter. The particulate collection system may embody particulate collection device facilitating the flow of a wash fluid through the reusable filter, carrying along its particulate contents, and into an enclosure, wherein the particulates may captured within the enclosure, while the wash fluid is discharges there from. The particulate collection device may include a filter seat and a particulate filter-collector removably attachable in a sealing engagement. The particulate filter-collector forms the enclosure housing a filter or a filter mesh. The filter seat forms a rinse chamber for the reusable filter to be submerged by wash fluid, wherein the rinse chamber and circumscribing portions thereof may be in fluid communication with the enclosure.

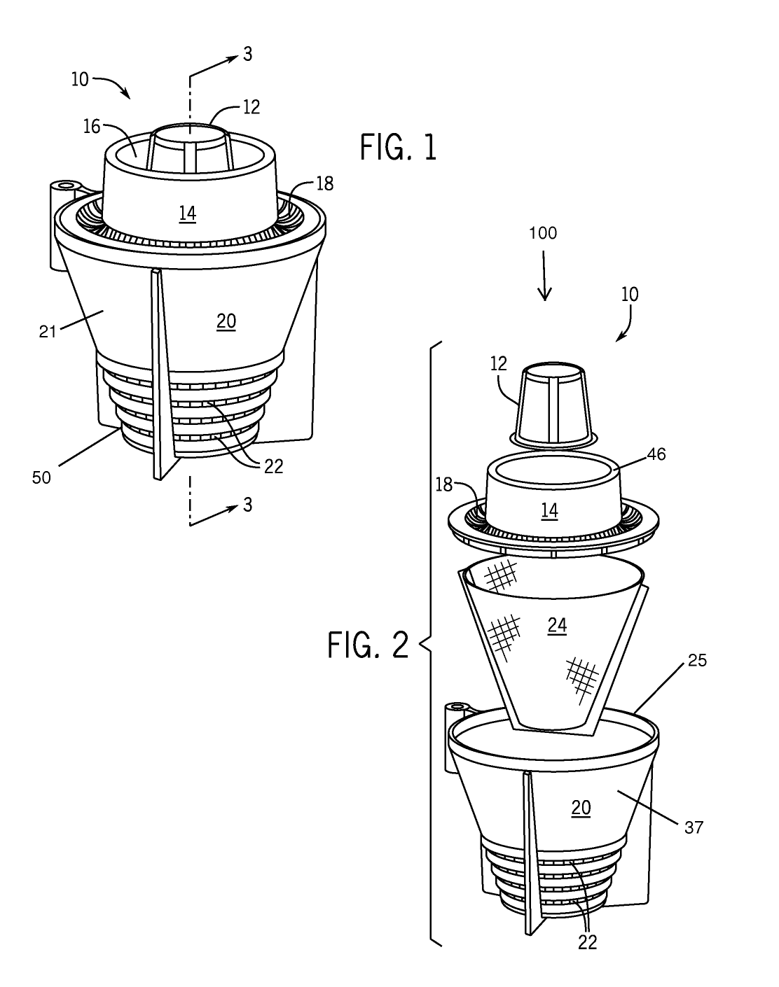

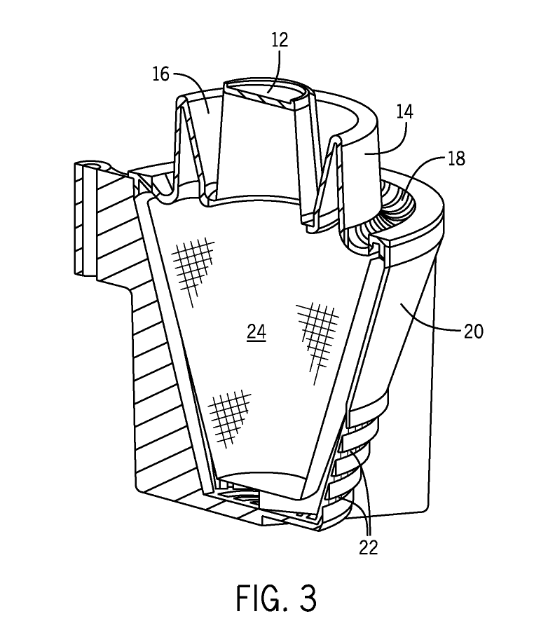

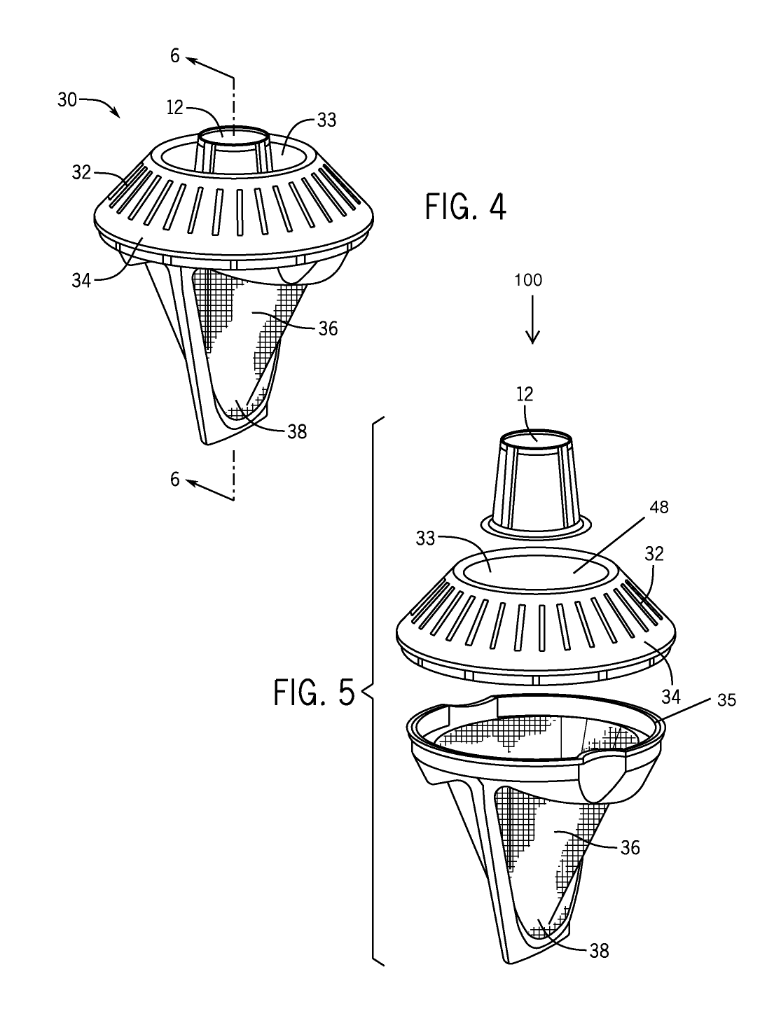

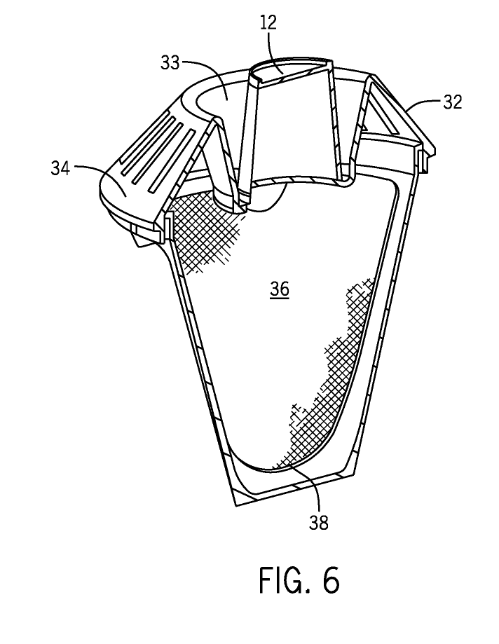

Referring to FIGS. 1 through 6, the present invention may include a particulate collection system 100 for the particulate contents of reusable filter 12. The particulate collection system 100 may embody several embodiments of a particulate collection device 10 or 30 and a method of using the same. The particulate collection device 10, 30 may include a reusable filter seat 14 or 34, fluidly connected to a particulate filter-collector 20 or 36, respectively.

The particulate filter-collector 20, 36 may include bowl-like sidewalls 21, 37 that form an enclosure having a fluid opening 25 or 35, respectively. The enclosure may be dimensioned and adapted to house particulate, and in certain embodiments, a disposable filter 24. The shape formed by the bowl-like sidewalls 21, 37 may be generally conical, cylindrical or any geometric or non-geometric shape so long as the sidewalls function in accordance with the present invention as described herein. In certain embodiments, a lower portion 50 of the sidewall of the particulate filter-collector 20 may form a plurality of drainage apertures 22. In an alternative embodiment, the drainage apertures may be a filter mesh 38 formed in a portion of the sidewall of the particulate filter-collector 36. Both the drainage apertures 22 and the filter mesh 38 facilitate the discharge of a wash fluid from the enclosure formed by the sidewalls. The disposable filter 24 and the filter mesh 38 may be dimensioned and adapted to retain particulate immersed in the wash fluid within the particulate filter-collector, while the wash fluid passes through.

The reusable filter seat 14 or 34 may by dimensioned and adapted to operatively engage each fluid opening 25 or 35 along the peripheries of both, so as to form a removable, sealed engagement. In the sealed engagement, a supporting flange may be formed along said peripheries. Each reusable filter seat 14, 34 may form a centrally disposed rinse chamber 16 or 33, respectively, and a plurality of fluid apertures 18 or 32 circumscribing said rinse chamber 16, 33, respectively. The plurality of fluid apertures 18, 32 may be dimensioned and adapted to allow particulate and wash fluid (and so particulate-immersed wash fluid) to be in fluid communication with their respective fluid opening 25, 35.

Each rinse chamber 16, 33 may be dimensioned and adapted to support the reusable filter 12 therein. Each rinse chamber 16, 33 may form generally vertical chamber walls 46, 48 dimensioned to substantially encompass a depth of the seated reusable filter 12 so that the rinse chamber 16, 33 can be filled with the washing fluid, substantially submerging said reusable filter 12. The chamber walls 46, 48 may be adapted to urge entering wash fluid to splash radially. Each rinse chamber 16, 33 may be dimensioned and adapted to allow particulate and wash fluid to be fluidly connected with their respective fluid opening 25, 35 facilitating drainage of particulate-immersed wash fluid from said rinse chamber. Moreover, wash fluid that overflows the chamber walls is gravitationally urged to flow through the fluid apertures 18, 32, and into said fluid opening 25, 35.

In certain embodiments, the plurality of fluid apertures 18 may be oriented generally perpendicular to a bottom portion of the chamber wall. In an alternative embodiment, the plurality of fluid apertures 32 may be oriented along an angle defined by an upper portion 42 of the chamber wall to the periphery of the filter seat 34.

The particulate collection system 100 generally fluidly communications the particulate-immersed wash fluid within the rinse chamber (and any overflowing the same) through the enclosure formed by the particulate filter-collector so that the immersed particulate is trapped therein on either the disposable filter 24 or the filter mesh 38, while the remaining wash fluid discharges.

A method of using the present invention may include the following. The particulate collection system 100 disclosed above may be provided. A user may place an inverted reusable filter 12 (containing particulate contents) within the respective rinse chamber 16, 33. Then the user may tap the inverted filter 12 directly or indirectly by tapping the particulate collection device 10, 30 by manipulating, for example, the supporting flange. After placing the particulate collection device 10, 30 in a sink or other drainage area, the user may pour a washing fluid into the rinse chamber 16, 33 so that the particulate-immersed wash fluid flows through the fluid opening 25, 35 and into the enclosure so that the particulate may be captured on the disposable filter 24 or the filter mesh 38, retained within the enclosure, as the remaining wash fluid discharges through the same and out of the enclosure.

Then the reusable filter 12 may be removed and used again. The enclosure may be dimensioned to receive several loadings or cycles of reusable filters 12 before being cleaned out by separating the sealed engagement of the reusable filter seat and the fluid opening peripheries. Thereby, dispensing of the particulate of each reusable filter 12 when, if desired, dry and in a more controlled manner.

The particulate collection system 100 may be adapted to be used for filtering coffee grinds from K-cup style filters or other food preparation separations. Alternatively, the particulate collection system 100 may be used as a batch type filtering, dewatering, parts rinsing/cleaning, particulate separation for many industries, including but not limited to aerospace, medical, electronics and the like.

It should be understood, of course, that the foregoing relates to exemplary embodiments of the invention and that modifications may be made without departing from the spirit and scope of the invention as set forth in the following claims.

What is claimed is:

1. A particulate collection device comprising:
a particulate filter-collector having at least one sidewall forming an enclosure communicating with a fluid opening;
a plurality of drainage apertures formed along the at least sidewall; and
a filter seat forming a centrally disposed chamber wall, wherein the filter seat is in fluid communication with the enclosure,
wherein the fluid opening and the filter seat peripheries are dimensioned and adapted to form a removable sealing engagement.

2. The particulate collection device of claim 1, wherein the chamber wall forms a rinse chamber in fluid communication with the enclosure.

3. The particulate collection device of claim 2, further comprising a plurality of fluid apertures formed in the filter seat so as to circumscribe the chamber wall.

4. The particulate collection device of claim 3, wherein the plurality of fluid apertures oriented approximately normal to a bottom portion of the chamber wall.

5. The particulate collection device of claim 3, wherein the plurality of fluid apertures are oriented along an angle defined by an upper portion of the chamber wall to the periphery of the filter seat.

6. The particulate collection device of claim 1, further comprising a disposable filter housed within the enclosure.

7. The particulate collection device of claim 1, wherein the plurality of drainage apertures are dimensioned to filter particulates.

8. A particulate collection device comprising:
a particulate filter-collector having at least one sidewall forming an enclosure communicating with a fluid opening;
a plurality of drainage apertures formed along the at least sidewall;
a filter seat forming a centrally disposed chamber wall, wherein the chamber wall forms a rinse chamber in fluid communication with the enclosure;
a plurality of fluid apertures formed in the filter seat so as to circumscribe the chamber wall, wherein the plurality of fluid apertures are oriented approximately normal to a bottom portion of the chamber wall; and
a disposable filter housed within the enclosure,
wherein the fluid opening and the filter seat peripheries are dimensioned and adapted to form a removable sealing engagement.

9. A particulate collection device comprising:
a particulate filter-collector having at least one sidewall forming an enclosure communicating with a fluid opening;
a plurality of drainage apertures formed along the at least sidewall, wherein the plurality of drainage apertures are dimensioned to filter particulates;
a filter seat forming a centrally disposed chamber wall, wherein the chamber wall forms a rinse chamber in fluid communication with the enclosure; and
a plurality of fluid apertures formed in the filter seat so as to circumscribe the chamber wall, wherein the plurality of fluid apertures are oriented along an angle approximately defined by an upper portion of the chamber wall to the periphery of the filter seat,
wherein the fluid opening and the filter seat peripheries are dimensioned and adapted to form a removable sealing engagement.
